(19) United States
(12) Patent Application Publication
(10) Pub. No.: US 2026/0322743 A1
(43) Pub. Date: Oct. 15, 2026

(54) Load Balancing in the WireGuard Protocol

(71) Applicant: Zscaler, Inc., San Jose, CA (US)

(72) Inventors: Satya Ranjan Mohanty, San Jose, CA (US); Nikolaos Triantafillis, San Jose, CA (US)

(73) Assignee: Zscaler, Inc., San Jose, CA (US)

(21) Appl. No.: 19/178,338

(22) Filed: Apr. 14, 2025

(51) Int. Cl. H04L 47/125; H04L 9/40; H04L 45/24

(52) U.S. Cl. CPC H04L 47/125; H04L 45/24; H04L 63/0236; H04L 63/0272

(57) ABSTRACT

Systems and methods for enhancing the WireGuard protocol are provided. In one implementation, a gateway device is arranged in a cloud-based system and connected via tunnels to multiple connectors in a client network. The gateway device is configured to assign loopback IP addresses to the multiple connectors and populate the loopback IP addresses into AllowedIP lists associated with the multiple connectors, the multiple AllowedIP lists addressing the connectors as crypto peers for use with the WireGuard protocol. Based on network operating parameters, the gateway device is configured to determine a packet routing plan for distributing multiple packets among the connectors. When a packet of the multiple packets is determined, according to the packet routing plan, to be routed through a connector other than a designated WireGuard peer, the gateway device further performs a step of encapsulating the packet with the corresponding loopback IP address of the connector.

### FIELD OF THE DISCLOSURE

The present disclosure relates generally to networking, computing, cybersecurity, Virtual Private Networks (VPNs), and the like. More particularly, the present disclosure relates to Zero-Trust Network Access (ZTNA) VPNs, specifically for extending the WireGuard protocol to include load balancing.

### BACKGROUND OF THE DISCLOSURE

ZTNA and VPNs both enable remote access, but they differ fundamentally in their underlying security approaches. VPNs, rooted in a traditional “castle-and-moat” model, grant users broad, network-level access once connected, which can expose more resources than necessary. In contrast, ZTNA applies a “never trust, always verify” philosophy, providing only application-specific, least-privileged access. This approach reduces an organization's attack surface, limits lateral movement, and offers granular, context-based controls. In modern hybrid and cloud environments, ZTNA's application-centric approach often delivers stronger security, better performance, and simpler scalability compared to conventional VPNs. Instead of extending the entire corporate network to remote users, cloud-based ZTNA solutions authenticate and authorize each connection at the application level, eliminating the need for on-premises hardware and avoiding inbound port exposure. As a result, they provide a more seamless and secure user experience overall.

A traditional VPN typically operates at lower layers of the OSI model (Layer 2 or Layer 3). When a user connects to a VPN, they are effectively placed inside the corporate network at the IP or Ethernet level and assigned an internal IP address. From the network's perspective, this user appears “inside” the organization, with broad visibility into network segments. By contrast, ZTNA focuses on higher-layer (often Layer 7) connections. Instead of granting full network access, it brokers user requests to specific applications. This means users cannot explore or discover IP addresses or services beyond what they are explicitly authorized to access, significantly reducing the risk of lateral movement.

While ZTNA provides clear operational and security benefits, there are some scenarios where it may not be the optimal choice. Certain applications, such as Voice over IP (VOIP) or those relying on server-initiated connections, require continuous, end-to-end network connectivity. For example, VoIP often involves real-time transmission over multiple dynamic ports and demands low latency-requirements that can be difficult to satisfy within ZTNA's more controlled, application-layer model. Likewise, in server-to-client communications, the server initiates the connection rather than simply receiving requests, which does not align well with ZTNA's user-initiated, application-specific approach.

Generally, WireGuard is a communication protocol that utilizes tunnels and implements encrypted VPNs. As a tunneling protocol, WireGuard is lighter, more efficient, and performs better than IPsec, OpenVPN, and SSL. The WireGuard protocol passes traffic over User Datagram Protocol (UDP), which is one of the main communication protocols of the Internet Protocol (IP) suite used to send messages (e.g., configured as datagrams within packets) to a host on an IP network. Within the IP network, UDP does not require prior communication to set up channels or data paths. UDP is a connectionless protocol, meaning that messages are sent without negotiating a connection (e.g., no handshaking). However, WireGuard inherently includes a restriction that limits communication over multiple connectors. Therefore, there is a need to enhance WireGuard to thereby work around this restriction for faster and more efficient transmission of packets.

### BRIEF SUMMARY OF THE DISCLOSURE

The present disclosure is directed to systems and methods for extending, enhancing, or improving the WireGuard protocol to provide a load balancing functionality. According to one implementation, a gateway device is arranged in a cloud-based system and connected via tunnels to multiple connectors in a client network. The gateway device is configured to perform a step of assigning loopback IP addresses to the multiple connectors and populating the loopback IP addresses into AllowedIP lists associated with the multiple connectors. The multiple AllowedIP lists addressing the connectors as crypto peers are for use with the WireGuard protocol. Based on network operating parameters, the gateway device is configured to perform a step of determining a packet routing plan for distributing multiple packets among the connectors. When a packet of the multiple packets is determined, according to the packet routing plan, to be routed through a connector other than a designated WireGuard peer, the gateway device is further configured to encapsulate the packet with the corresponding loopback IP address of the connector.

In some embodiments, the gateway device may be further configured to perform steps of a) receiving the multiple packets from one or more sources arranged in the cloud-based system, and b) forwarding the multiple packets, via the tunnels and multiple connectors, to a client device arranged in the client network. Also, each of the multiple packets may include payload and an IP header, wherein the IP header may include at least a (source, destination) tuple, and wherein the destination of the tuple may be associated with the client device. The step of forwarding the multiple packets, for example, may include transmitting the multiple packets in such a way so as to essentially balance the load among multiple paths, each of the multiple paths including one of the tunnels and one of the multiple connectors.

According to some embodiments, the steps may be performed so as to extend the WireGuard protocol to support a load balancing strategy for substantially balancing the load among parallel network paths leading to a host node in the client network. The load balancing strategy, for example, may be adapted to account for one or more of a) packet size of each of the multiple packets, b) routing costs of each of network paths, c) latency along the network paths, d) the availability and fault status of the network paths, e) Equal Cost Multi-Path (ECMP) factors, f) Unequal Cost Multi-Path (UCMP) factors, and g) the availability of backup, protection, or recovery paths.

Furthermore, the multiple connectors may be configured as edge devices arranged to delineate an edge of the client network. The loopback IP addresses, for example, may be class E addresses in IPv4 ranging from 240.0.0.0 to 255.255.255.255. The packet routing plan for distributing multiple packets among the connectors, according to some implementations, may be configured to bypass a restriction of the WireGuard protocol regarding transmission of packets through the designated WireGuard peer. The cloud-based system, for example, may be a Zero-Trust Network Access (ZTNA) Virtual Private Network (VPN) system. In addition, the gateway device may further be configured to perform a step of assigning a loopback IP address to itself. Also, when a packet of the multiple packets is determined, according to the packet routing plan, to be routed through the designated WireGuard peer, the gateway device may be configured to bypass the encapsulating step.

In some embodiments, the gateway device may further be configured to perform steps of a) encrypting the multiple packets according to the WireGuard protocol, and b) encapsulating the multiple packets in a User Datagram Protocol (UDP) packet according to the WireGuard protocol. The multiple packets determined to be routed through connectors other than the designated WireGuard peer, for example, may be encapsulated twice. The gateway device may transmit the multiple packets to the multiple connectors such that 1) the connector designated as the WireGuard peer is able to obtain a destination IP address of a host device on the client network and transmit the packet accordingly, and 2) one or more connectors not designated as the WireGuard peer are able to infer the loopback IP address as encapsulated traffic, decapsulate the packet to obtain the destination IP address, and transmit the packet accordingly. The gateway device, for example, may be configured as a WireGuard interface.

### BRIEF DESCRIPTION OF THE DRAWINGS

The present disclosure is illustrated and described with reference to the various drawings. Like reference numbers are used to denote like components/steps, as appropriate. Unless otherwise noted, components depicted in the drawings are not necessarily drawn to scale.

FIG. 1 illustrates a network diagram of a cloud-based system that provides various services, including ZTNA access to applications.

FIG. 2 illustrates a block diagram of a computing system that may be used to implement various components described in this disclosure.

FIG. 3 illustrates a network that includes components within the cloud-based system for delivering ZTNA-enabled VPN access to two example client endpoint devices.

FIG. 4 illustrates a flowchart of a process for enabling zero-trust network access (ZTNA)-enabled virtual private network (VPN) connectivity in a cloud-based system that includes a network presence (NP) gateway.

FIG. 5 illustrates a flowchart of a process for providing zero-trust network access (ZTNA) private application connectivity and ZTNA-enabled virtual private network (VPN) connectivity.

FIG. 6 illustrates a communication network for delivering packets from a source to a client device.

FIG. 7 illustrates another communication network for delivering packets from sources to a client device.

FIG. 8 illustrates yet another communication network for delivering packets from sources to a client device.

FIG. 9 illustrates a block diagram of the gateway device shown in FIG. 8.

FIG. 10 illustrates a flowchart of a process for balancing a load of packets within the WireGuard protocol.

### DETAILED DESCRIPTION OF THE DISCLOSURE

Again, a VPN solution allows remote users to securely access an organization's internal network as if they were physically present onsite. By creating a tunnel at the Internet Protocol (IP) or Ethernet level (Layer 2 or Layer 3 of the OSI model), VPNs assign a remote device an internal IP address and route all user traffic through a VPN concentrator. This effectively extends the corporate network to the user's location, making it straightforward to access resources such as file servers, intranet sites, or enterprise apps. VPNs also support applications that require continuous, end-to-end connectivity—like Voice over IP (VOIP)—because they provide the equivalent of a local network connection, maintaining persistent sessions and real-time data transfer. Additionally, organizations can choose from a variety of well-established VPN protocols (e.g., IP Security (IPSec), secure sockets layer (SSL)/transport layer security (TLS)) to encrypt traffic, ensuring data privacy over untrusted networks like the public internet.

However, this broad network-level access also presents security challenges. Once connected, a remote device is effectively “inside” the corporate firewall, creating a larger attack surface. If a malicious actor compromises a remote user's device, they can exploit the VPN tunnel to move laterally across the internal network, probing and potentially accessing systems that were never intended to be exposed. Even if firewalls or access control lists partially restrict certain network segments, attackers can still gain valuable insight into network topology and services running on the internal infrastructure. Moreover, managing and segmenting access for every VPN user can become complex, especially in larger environments. These factors make VPNs a double-edged sword: indispensable for certain scenarios requiring full network connectivity, yet prone to increasing the organization's overall risk posture if not carefully implemented and maintained.

### Cloud-Based System

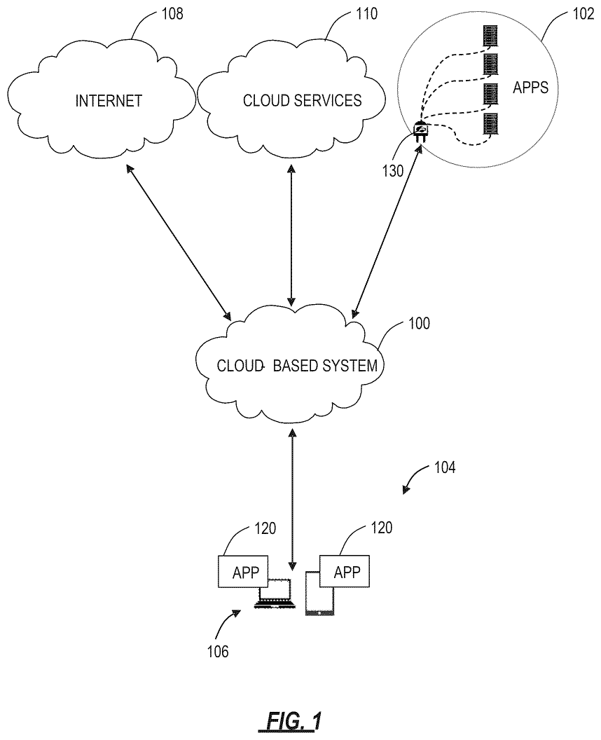

To address the limitations of traditional VPN solutions, organizations have adopted Zero Trust Network Access (ZTNA) as part of a cloud-based security model. FIG. 1 illustrates a network diagram of a cloud-based system 100 that provides various services, including ZTNA access to applications 102. In this architecture, the cloud-based system 100 serves as a secure intermediary between users 104 (and their endpoint devices 106), the Internet 108, cloud services 110, and private applications 102. In addition to ZTNA, the cloud-based system 100 can implement services like a secure web gateway (SWG), secure service edge (SSE), and secure access service edge (SASE). A tenant-such as an enterprise or other organization-manages users 104, who access these cloud services via corresponding endpoint devices 106. While the term “user” 104 is used throughout, it implies use of an associated endpoint device 106 for interacting with the cloud-based system 100. Also, the cloud-based system 100 supports multi-tenancy, namely users 104 from different tenants, with granular policies, reporting, etc.

Logically, the cloud-based system 100 functions as an overlay network that provides security and connectivity services independently of physical geography, local platform constraints, or network providers. In traditional IT deployments, enterprise resources and applications were hosted in a corporate data center behind a firewall, with remote users accessing them via VPN tunnels that often granted broad network-level access. By contrast, the cloud-based system 100 replaces this perimeter-focused model with a cloud-delivered approach. Instead of installing and managing numerous physical devices and appliances, enterprise IT administrators rely on the cloud-based system 100 to perform the same functions-securely brokering traffic and providing zero-trust controls-wherever users 104 are located. This design not only relieves organizations of managing hardware appliances but also reduces the attack surface by minimizing the need for inbound open ports and traditional VPN concentrators.

A key advantage of the cloud-based system 100 is that it intercepts and inspects all user traffic, enabling powerful security features such as zero-trust enforcement. Different techniques can be used to direct traffic through the cloud-based system 100. In some deployments, specific sites establish tunnels (e.g., GRE, L2TP, IPsec) that forward all traffic to the cloud-based system 100, while in others, endpoint devices 106 run a client connector 120 that intelligently routes traffic. Regardless of the method, the result is that all data flowing between users 104 and the Internet 108, cloud services 110, or applications 102 passes through the cloud-based system 100. By operating as an always-on overlay network, the cloud-based system 100 applies zero-trust principles-verifying user identity, device posture, and application context-without relying on a broad, network-layer tunnel. In doing so, it addresses the key challenges of legacy VPN solutions: reducing the attack surface, preventing lateral movement, and eliminating the need for users to join the corporate network at a lower OSI layer.

### Client Connector

The client connector 120 is a lightweight software agent installed on endpoint devices 106—such as laptops, desktops, or mobile devices—that securely routes user traffic to the cloud-based system 100. Once installed, it inspects system attributes (e.g., OS version, security posture) and applies policy-based controls to determine whether traffic should be forwarded for further inspection or enforcement. Operating at the network and application layers, the client connector 120 leverages domain name system (DNS) interception or tunneling technologies to capture both web and non-web traffic. It then directs these data flows to the cloud-based system 100, where a suite of security services-such as SWG, cloud firewall, cloud sandbox, data loss prevention (DLP), ZTNA, and the like—are applied based on granular, context-aware policies. By dynamically evaluating user identity, device health, and application context, the client connector 120 facilitates a zero-trust model for secure connectivity, helping organizations extend consistent security controls to remote or mobile users without forcing all traffic back through on-premises gateways.

### ZTNA

By contrast to VPNs, a ZTNA private application access solution operates at higher layers of the OSI model (often Layer 7), providing granular, application-level security rather than granting broad network access. In the architecture shown in FIG. 1, the cloud-based system 100 authenticates and authorizes each connection request at the application layer, ensuring the user 104 only sees and accesses the specific resources they are permitted to reach. To facilitate this, the user 104 connects to the applications 102—which may reside in an enterprise network, a data center, or a public or private cloud-through an application connector 130. This connector 130 sits between the endpoint device 106 and the applications 102, validating user identity, device posture, and contextual factors (e.g., location or time of day) before granting a tailored, least-privileged session. Traffic then flows through secure tunnels that are created on demand via the cloud-based system 100, but crucially, these tunnels do not expose the underlying network topology. Instead, the applications 102 remain “dark” to the outside world, which drastically reduces the corporate attack surface and prevents lateral movement. This design aligns well with modern, cloud-heavy deployments by offering simpler scalability, granular security policies, and more robust controls than traditional VPNs that operate at lower network layers.

ZTNA's focus on application-level connections can pose challenges for certain workloads that require continuous, bidirectional, or real-time communication at the network layer. For example, Voice over IP (VOIP) often relies on dynamic port assignments, real-time audio/video streams, and consistent end-to-end connectivity-attributes that are difficult to accommodate when access is brokered at the application layer without direct network visibility. Likewise, server-initiated communications (e.g., remote management tools or specific legacy protocols) depend on the ability to reach client devices on-demand, which ZTNA's “outbound-only” or “user-initiated” tunnel model does not readily support. Because ZTNA does not assign a network address to remote endpoints inside the corporate environment, it cannot easily route inbound traffic from servers to clients, nor can it handle protocols expecting unfettered LAN-like access. Consequently, while ZTNA excels at securing user-to-application interactions, traditional VPNs may still be necessary for use cases involving continuous or server-led network traffic that ZTNA's strictly controlled, application-specific approach struggles to handle.

### Application Connector

The application connector 130, also referred to as an app connector, is a lightweight software component deployed at the application 102, which can be in an organization's network, a data center, etc.—typically in the same subnet or environment where the private application 102 resides. The application connector 130 provides secure, outbound-only connectivity between the application 102 and authorized remote users 104. Unlike traditional VPN concentrators that require inbound ports and network-layer tunnels, the application connector 130 builds a secure, outbound connection or tunnel (e.g., TLS) to the cloud-based system 100.

Deployment Location & Network Topology—The application connector 130 can be installed on a virtual machine (or sometimes a physical server) within the organization's own environment (data center, private cloud, public cloud, etc.). The application connector 130 can sit behind a corporate firewall but does not require any inbound ports to be opened. Instead, the connector 130 initiates an outbound 443/TLS connection to the cloud-based system 100, ensuring that no listening services are exposed on the public internet.

Outbound-Only Connectivity—All communication between the connector 130 and the cloud-based system 100 is initiated from inside the network. This outbound-only model eliminates the need for public IPs or inbound network address translation (NAT) rules. The connector 130 maintains a persistent secure tunnel to the cloud-based system 100, which serves as the rendezvous point for remote-user sessions.

Application Discovery & Mapping—Administrators define “application segments” within an admin console, associated with the cloud-based system 100, specifying fully qualified domain names (FQDNs), IP ranges, and TCP/UDP ports that represent the internal services to be published. The connector 130 is associated with these application segments, so it “knows” which private applications it can broker access to. This ensures that only explicitly configured resources are accessible; anything else remains invisible (“dark”) to external users 104.

Dynamic Session Brokering—When a remote user 104 requests access to a private application 102, the cloud-based system 100 verifies the user's identity, device posture, and contextual policy checks (e.g., time of day, geolocation, etc.). If authorized, the cloud-based system 100 instructs the connector 130 to accept the user session. Traffic from the user 104 flows through a separate secure tunnel from the user's device to cloud-based system 100, which then stitches it together with the connector's 130 outbound tunnel from the application 192—without ever exposing the internal network or assigning the user 104 a local IP address.

Context-Aware Security Enforcement—The connector 130 does not simply “port forward” or provide network-layer bridging. Instead, it enforces a Zero Trust model at the application layer, allowing access only to the FQDNs/ports specified by policy. This granular, application-level control prevents lateral movement. Even if an attacker compromised a user's endpoint device 106, they would only be able to reach the specifically authorized application instances.

Scalability & High Availability—Multiple application connectors 130 can be deployed across different environments or geographic locations to scale capacity or provide redundancy. Each connector 130 is managed centrally from the admin console. Because each connector 130 creates an outbound link to the same cloud-based system 100, organizations can expand or contract deployments without rearchitecting networks or provisioning new public IP addresses.

Reduced Attack Surface—By eliminating inbound connections and relying on user- and application-level policies, the application connector 130 significantly reduces an organization's external attack surface. The private applications 102 remain “dark”—unexposed to port scans or direct internet probing—since the only incoming path is via the cloud-based system's 100 authenticated and authorized sessions.

Integration with Existing Infrastructure—The application connector 130 can coexist with existing firewall, proxy, or network equipment. It usually only needs outbound access on port 443. It also integrates with identity providers and endpoint posture checks to enforce consistent policies for both internal and remote users.

In essence, the application connector 130 acts as a “reverse connector” that projects private applications 102 into the cloud-based system 100, where zero-trust policies can be enforced for remote users. Because it operates at higher layers of the OSI model and never grants broad network access, it embodies the core Zero Trust principle of “least-privileged access,” thereby minimizing lateral movement risks and overall exposure.

### Computing System

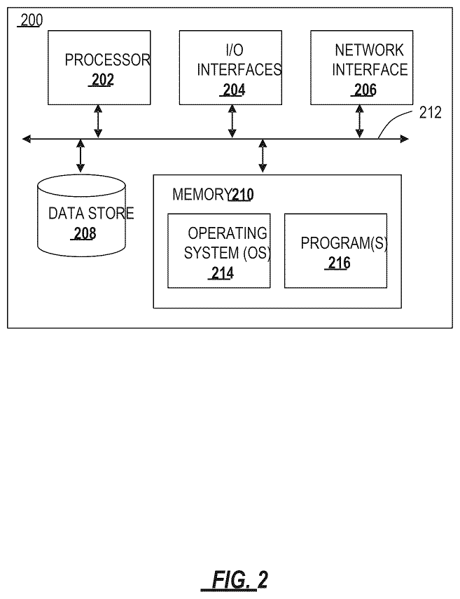

FIG. 2 illustrates a block diagram of a computing system 200 that may be used to implement various components described in this disclosure. The computing system 200 can take multiple forms, including but not limited to laptops, desktops, smartphones, tablets, physical servers, clusters of machines, virtual machines (VMs) running on hypervisors, or serverless computing frameworks. Despite differing hardware implementations, the computing system 200 generally comprises one or more processors 202, input/output (I/O) interfaces 204, a network interface 206, a data store 208, and memory 210. While FIG. 2 provides a simplified representation, real-world deployments can include additional hardware and software elements. These components 202, 204, 206, 208, 210 connect via a local interface 212, which may include wired or wireless buses, high-speed interconnects, or other switching fabrics.

Each processor 202 is a hardware element—such as a central processing unit (CPU), multicore processor, system-on-chip (SoC), graphics processing unit (GPU), or a processing element within a larger compute cluster—designed to execute software instructions. These processors can be general-purpose or specialized, depending on performance, power efficiency, or workload requirements. During operation, each processor 202 retrieves instructions from memory 210, manages data within the data store 208, and orchestrates the overall functioning of the computing system 200. In larger-scale environments, multiple processors 202 may run in parallel to handle higher volumes of network traffic or complex workloads.

The I/O interfaces 204 allow the computing system 200 to interact with external peripherals for user input (e.g., keyboards, touchscreens, sensors) and system output (e.g., displays or printers). Depending on the application, these I/O interfaces 204 can also connect to specialized devices for maintenance, debugging, or administrative tasks. Meanwhile, the network interface 206 manages connectivity to external networks—whether the Internet, private intranets, or cloud-based environments. This interface can utilize Ethernet, wireless LANs, cellular connections, or virtual cloud endpoints. By employing secure transport protocols (e.g., TLS/SSL, IPsec), the network interface 206 ensures that data exchange with remote entities remains protected, allowing the computing system 200 to operate safely in distributed or cloud-focused deployments.

The data store 208 provides both persistent and temporary storage. It can encompass volatile memory (e.g., random access memory (RAM)) for high-speed operations and nonvolatile media (e.g., solid-state drives, hard disk drives, optical discs) for long-term data retention. In some configurations, the data store 208 may integrate with network-attached storage (NAS), storage area networks (SAN), or cloud-based storage solutions. These setups can range from small on-premises installations to large, geographically distributed systems offering deduplication, compression, encryption at rest, and multi-site replication. The data store 208 may hold operational logs, system configurations, policy rules, software binaries, or cached computation results.

The memory 210 typically functions as the primary working memory for the processors 202. It can include volatile elements (e.g., dynamic RAM (DRAM), double data rate (DDR), synchronous DRAM (SDRAM)) for faster access, as well as nonvolatile components like flash memory or non-volatile RAM (NVRAM). In large-scale cloud environments, memory 210 may be distributed across multiple nodes or servers to support in-memory processing for high-throughput workloads. Typically, the memory 210 stores the operating system (O/S) 214 and one or more programs 216. The O/S 214 manages core system functions such as process scheduling, memory allocation, file handling, and network communication.

For Software-as-a-Service (SaaS) or similar cloud-hosted components—such as those in the cloud-based system 100—the computing system 200 can be deployed in diverse ways: within a private cloud in a single organization's data center, through a public cloud provider, or as part of a hybrid cloud model combining both. Cloud computing decouples the physical layer of servers, storage, and networks into virtualized, on-demand resources. Organizations can thus scale compute capacity, storage, and network bandwidth rapidly and cost-effectively, aligning with fluctuating workloads. As defined by the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” By delivering applications via web interfaces or lightweight clients, cloud providers can consistently push updates, deploy new features, and enforce security patches, minimizing the overhead typically associated with local installations and version management.

Different embodiments of the computing system 200 may employ various forms of processing hardware, including general-purpose microprocessors, digital signal processors (DSPs), network processors, graphics processors (GPUs), field-programmable gate arrays (FPGAs), or programmable logic devices (PLDs). Such hardware can be managed by software, firmware, or both, and may work in tandem with dedicated circuitry to accomplish specific tasks. Certain operations can be implemented via state machines or in application-specific integrated circuits (ASICs) to optimize performance and power efficiency. Additionally, implementations can leverage a non-transitory, computer-readable storage medium containing instructions that, when executed by the computing system 200, cause it to perform the methods or algorithms described herein. Common examples of such storage media include hard disks, optical discs, magnetic storage, read-only memory (ROM), flash memory, and other types of persistent or semi-persistent storage. Once stored and executed, these instructions enable the system to implement the disclosed functionality.

### ZTNA-Enabled VPN Solution

A ZTNA-enabled VPN solution combines the strengths of both VPN and ZTNA models to address the limitations of traditional VPNs while improving overall security, scalability, and user experience. In this hybrid architecture, the familiar VPN framework is enhanced by zero-trust principles, ensuring continuous verification of user identity, device posture, and application context. More specifically, the ZTNA-enabled VPN solution provides network presence (NP) for a user 104 through the cloud-based system 100—for instance, via a WireGuard-based tunnel—allowing endpoint devices 106 to operate at the network layer for use cases such as VoIP, server-initiated connections, and other real-time or bidirectional applications. According to embodiments of the present disclosure, ZTNA enforcement is applied within this VPN tunnel, preventing unrestricted lateral movement and limiting access to only the resources that are explicitly authorized.

Network Presence (NP) was introduced to fulfill two example requirements: extending ZTNA to support VoIP traffic and providing a more traditional, full-tunnel VPN solution. For VoIP scenarios, NP incorporates a pseudo-STUN component that handles real-time communication; in practice, this also accommodates protocols like H.323, which do not rely on SIP or STUN. Concurrently, some customers requested an “old-school” VPN approach to ensure continuous network connectivity—an approach that likewise supports VoIP. NP modernizes this legacy VPN model by implementing per-destination controls instead of granting blanket network access. Moreover, unlike older VPN gateways that reside in a local area network (LAN) or demilitarized zone (DMZ) and require inbound firewall ports to be opened, NP initiates tunnel connections from inside the LAN, removing the need for any externally exposed ports. This design upholds a zero-trust posture, reduces the attack surface, and offers the network-layer visibility essential for VoIP and server-to-client communications.

Meanwhile, the solution preserves traditional ZTNA application access via the application connector 130, delivering granular, application-specific connectivity without exposing the entire network. This ensures that users 104 benefit from both a network presence (when lower-layer protocols are necessary) and the robust, per-application security of ZTNA. Additionally, the ZTNA-enabled VPN solution can integrate with existing identity providers and device posture checks, supporting conditional policies such as time-of-day restrictions, geolocation filtering, and multifactor authentication. Altogether, this approach grants enterprises the flexibility to accommodate a wide range of application types-including those requiring full network connectivity—while adhering to zero-trust best practices to minimize attack surfaces and mitigate the risk of lateral movement.

Benefits of this Hybrid Approach Include:
(1) Enhanced Security-Granular Access Control: ZTNA ensures that users are granted access only to specific applications and resources based on identity, device health, location, and context. This limits unauthorized access and reduces the risk of lateral movement within the network. Continuous Verification: Unlike VPNs that authenticate users only at the point of entry, ZTNA continuously verifies user and device trust throughout the session, minimizing the risk of compromised sessions. Minimized Attack Surface: With ZTNA, applications remain hidden from the public internet, reducing exposure to external threats such as DDOS attacks, malware, and unauthorized access. Micro-Segmentation: ZTNA enforces strict segmentation, ensuring that even if one part of the network is compromised, other segments remain secure.
(2) Improved Scalability and Flexibility-Cloud-Native Architecture: ZTNA solutions often leverage cloud infrastructure, making it easier to scale as organizational needs grow without the limitations of traditional VPN hardware. Device Agnosticism: Supports secure access from a variety of devices, including BYOD, mobile, and desktops, without compromising security.
(3) Seamless User Experience-Optimized Performance: ZTNA directs traffic through the nearest points of presence, reducing latency compared to routing all traffic through a central VPN gateway. Simplified Access Management: Users gain secure access to necessary applications without complex VPN configurations.
(4) Reduced Operational Overhead-Centralized Policy Management: Administrators can define and enforce access policies centrally, ensuring consistency.
(5) Addressing VPN Limitations-Eliminates Overly Broad Access: ZTNA limits access to only necessary resources, reducing potential damage from compromised accounts. Mitigates VPN Performance Bottlenecks: ZTNA's distributed architecture reduces strain on VPN servers.
(6) Addressing ZTNA Shortcomings with VPN Integration-Support for Legacy Systems: Pure ZTNA solutions may not support legacy applications reliant on traditional network access; a ZTNA-enabled VPN can bridge this gap. Comprehensive Connectivity: ZTNA alone may face challenges in providing full network connectivity required by some enterprise applications; integrating VPN ensures seamless access. Reduced Implementation Complexity: Deploying ZTNA from scratch can be complex; integrating it with an existing VPN infrastructure allows a smoother transition. Fallback Mechanism: In scenarios where ZTNA policies face misconfigurations or failures, the VPN component can serve as a fallback to ensure uninterrupted access.

A ZTNA-enabled VPN solution provides a robust, secure, and scalable framework for modern organizations, combining the trusted remote access of VPNs with the dynamic, context-aware controls of ZTNA. This hybrid approach not only enhances security and performance but also addresses the limitations of both VPN and ZTNA, offering the best of both worlds in network security and access management.

### ZTNA-Enabled VPN Architecture

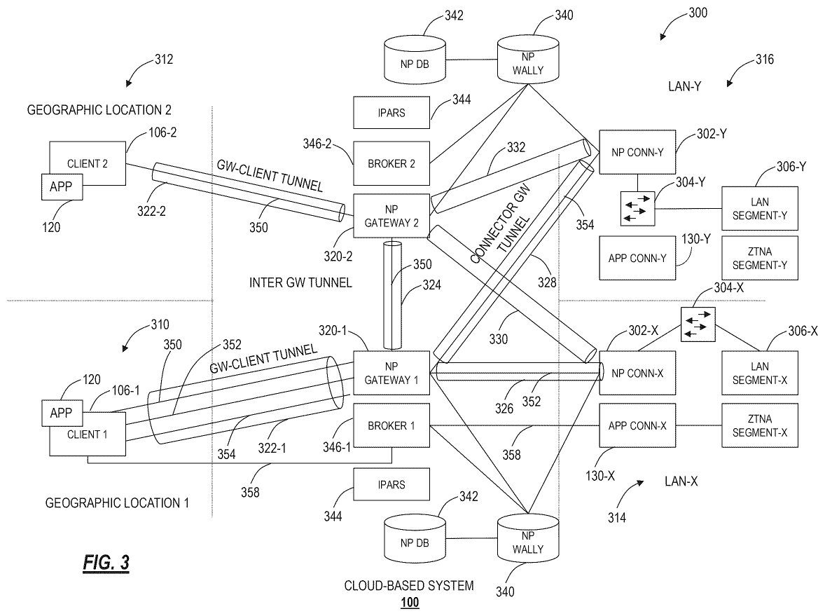

FIG. 3 illustrates a network 300 that includes components within the cloud-based system 100 for delivering ZTNA-enabled VPN access to two example client endpoint devices 106-1, 106-2. Of note, the example network 300 is simplified for illustrative purposes, and actual deployments will include additional components. In this architecture, network presence (NP) connectors 302-X, 302-Y function similarly to the application connectors 130, but reside in front of gateways (GW) 304-X, 304-Y that serve LAN segments 306-X, 306-Y rather than private applications 102. The NP connectors establish secure tunnels (e.g., WireGuard-based) with the cloud-based system 100, providing ZTNA-like controls for network-level access—particularly useful for VoIP, server-to-client connections, and other workloads requiring bidirectional or real-time communication.

According to preferred embodiments, the NP connectors 302-X, 302-Y enforce zero-trust policies for LAN resources in the same way application connectors 130 do for individual applications 102, yet focus on granting LAN access instead of per-application access. This approach enables users 104 to reach lower-layer network services without exposing the entire LAN or requiring inbound firewall ports. At the same time, the application connector 130 remains available to deliver granular, application-level security for private applications 102. In practice, both connectors work in tandem through a single client connector 120 on each endpoint device 106, enabling seamless user access to LAN-based resources via NP connectors 302-X, 302-Y while also providing traditional, application-specific ZTNA through the application connector 130. This unified design preserves zero-trust enforcement across all connectivity scenarios, minimizes the attack surface, and offers the flexibility needed to support a wide variety of application requirements.

FIG. 3 depicts a simplified example of a network 300 with two geographic locations 310 and 312, each hosting a respective client endpoint device (106-1, 106-2) equipped with a client connector 120. These locations can be remote offices, user homes, hotels, or public Wi-Fi hotspots. The network 300 also includes two local area network (LAN) segments, 314 (labeled LAN-X) and 316 (labeled LAN-Y). Positioned as an overlay between the geographic locations 310, 312 and the LAN segments 314, 316 is the cloud-based system 100, which orchestrates ZTNA-enabled VPN connectivity and enforces zero-trust policies.

Within this setup, the client endpoint devices 106-1 and 106-2 establish secure connections—referred to as GW-client tunnels 322-1, 322-2—to NP gateways 320-1, 320-2 in the cloud-based system 100. These tunnels are commonly implemented via WireGuard or similar protocols, with the client connector 120 configured as an NP client to support such connectivity. The NP gateways 320-1, 320-2 are themselves linked by an inter-GW tunnel 324, enabling seamless traffic flow within the cloud-based system 100. From each NP gateway 320-1, 3202, additional connector GW tunnels 326, 328, 330, 332 extend to the LAN segments 314, 316, terminating at the NP connectors 302-X, 302-Y. These NP connectors 302-X, 302-Y provide zero-trust network access to LAN resources—such as VoIP systems or server-to-client applications—while ensuring no inbound firewall ports need to be opened. The cloud-based system 100 also includes an NP Wally module 340, an NP database (DB) 342, an IP management system (IPARS) 344, and multiple application brokers 346-1, 346-2, which handle aspects like policy enforcement, IP address allocation, and application-level routing.

For illustrative connectivity scenarios, the endpoint device 106-1 can communicate with endpoint device 106-2 via a connection 350 that traverses GW-client tunnel 322-1, NP gateway 320-1, the inter-GW tunnel 324, the NP gateway 320-2, and the GW-client tunnel 322-2. This allows for ZTNA-enforced client-to-client connectivity without exposing sensitive infrastructure. Similarly, the endpoint device 106-1 can access LAN segment 314 over a connection 352 that flows through the GW-client tunnel 322-1, the NP gateway 320-1, the connector GW tunnel 326, and finally reaches the NP connector 302-X. A comparable connection 354 lets the endpoint device 106-1 reach the LAN segment 316 via the connector GW tunnel 328 and the NP connector 302-Y. Meanwhile, the endpoint device 106-1 can separately leverage application brokers 346-1, 346-2 for private application access via ZTNA. For example, a connection 358 may involve distinct secure tunnels from the endpoint device 106-1 to the application broker 346-1 and from there to an application connector 130-X, ultimately providing per-application security. In this manner, a single endpoint device 106-1 can seamlessly utilize both ZTNA-enabled VPN (for LAN-level connectivity) and standard ZTNA (for private applications 102), all under the unified oversight of the cloud-based system 100.

The NP connector 302 provides functionality similar to the application connector 130, but specifically for granting network-level access to the LAN segments 308 instead of per-application access to resources (the applications 102). Like its counterpart, the NP connector 302 is a lightweight software component hosted within the LAN segment 306. However, rather than connecting directly to private applications 102, the NP connector 302 initiates secure tunnels to the NP gateways 320, analogous to how the application connector 130 establishes connections for application-level ZTNA. In this setup, the default gateway 304 (for the LAN) routes all packets destined for remote subnets to the NP connector 302 as the next hop. Acting both as a router and as a tunnel endpoint, the NP connector 302 encapsulates these outbound packets and sends them to the appropriate NP gateway 320 in the cloud-based system 100. On the return path, it de-encapsulates incoming packets and forwards them back to the default gateway 304, which then delivers them to the correct destination on the LAN. This design removes the need for any inbound open ports, since all tunnel connections originate from within the LAN. In some embodiments, the NP connector 302 may be integrated with the application connector 130, allowing organizations to consolidate both LAN-focused and application-focused connectivity into a single software component while maintaining a zero-trust security posture.

Each NP gateway 320 is typically deployed as a virtual machine within the cloud-based system 100, often co-located with the application brokers 346 for efficiency and shared infrastructure. The NP gateway 320 hosts a well-known IP and port pair that both the NP client (running in the client connector 120) and the NP connectors 302 use to initiate WireGuard tunnels. This design leverages outbound-only connections, where the NP client and NP connectors 302 establish secure tunnels to the NP gateway's known IP address, removing the need to open inbound ports in either the LAN or the cloud environment.

To facilitate client-to-client communication, each NP gateway 320 also forms connections to every other NP gateway 320 in the cloud-based system 100, creating a mesh-like structure. When traffic arrives from an NP client or an NP connector, the NP gateway 320 “bridges” these inbound tunnels—ensuring data can be routed appropriately between different LAN segments or endpoint devices. Notably, the NP gateway 320 only initiates outbound connections when setting up or maintaining these inter-gateway tunnels; it does not accept inbound sessions from unknown sources. This architectural choice enforces a zero-trust posture, as all tunnels originate from trusted components (the client connector 120, NP connectors 302, or other NP gateways 320) and are authenticated via WireGuard's cryptographic handshakes.

Within the client connector 120, the NP client includes a set of processes or threads tasked with establishing WireGuard tunnels to the NP gateways 320 in a predefined sequence. For instance, the NP client may attempt a connection with the first gateway in a list, then proceed to the second if necessary, and so on. Once a tunnel is successfully created, the NP client configures routes for the Classless Inter-Domain Routing (CIDR) blocks accessible through Network Presence. Additionally, the NP client handles NP FQDN resolution by utilizing pre-configured NP DNS servers, ensuring that any fully qualified domain names within the NP domain are resolved correctly without requiring external DNS lookups.

Establishing and maintaining these secure WireGuard tunnels necessitates robust key management, facilitated by the NP Wally module 340 and the NP DB 342. The NP client, NP connector 302, and NP gateways 320 each include key management logic that collaborates with the NP Wally module 340 for key distribution. Acting as a centralized key authority, the NP Wally module 340 pulls from—or stores keys in—the NP DB 342, thereby synchronizing cryptographic materials across all Network Presence components. This design enforces consistent cryptographic policies, supports re-keying when needed, and ensures each tunnel meets the stringent security requirements of a Zero Trust architecture.

When a remote user or device initiates network presence, the cloud-based system 100 coordinates with the IP Address Reservation Service (IPARS) 344 to assign a unique IP address for the NP client's virtual interface. As soon as the NP client connects, IPARS consults the NP DB 342 to obtain an available address range specific to Network Presence, then delivers the appropriate IP assignment to the NP client. By managing IP address distribution centrally, IPARS 344 eliminates conflicts and streamlines endpoint provisioning, enabling the NP client to integrate seamlessly with LAN segments and other network services under the Network Presence framework.

### WireGuard Tunnels

WireGuard is described in Donenfeld, Jason A. “WireGuard: Next Generation Kernel Network Tunnel.” NDSS. 2017, the contents of which are incorporated by reference. WireGuard tunnels provide an efficient, modern approach to securing traffic for Network Presence in ZTNA-enabled VPN environments. Designed as a lightweight Layer 3 VPN solution, WireGuard incorporates state-of-the-art cryptographic primitives (such as Curve25519 for key exchange and ChaCha20 for encryption) in a codebase significantly smaller and simpler than traditional protocols like IPsec or SSL/TLS. This minimal complexity reduces both attack surface and the risk of implementation errors while delivering excellent performance due to its streamlined kernel-space operation. Unlike many SSL- or TLS-based VPN solutions, WireGuard establishes peer connections through ephemeral key pairs and maintains only minimal connection state, allowing rapid reconnection across changing networks or fluctuating IP addresses—ideal for mobile clients. Additionally, its built-in cryptokey routing allows user identity to be tied directly to cryptographic keys, aligning naturally with zero-trust principles by eliminating the need for user-level certificates or complex session management. As a result, organizations deploying ZTNA-enabled VPNs benefit from faster tunnel initialization, lower overhead, and a hardened security model that is easier to audit, maintain, and scale across distributed environments.

### Remote Client Partitions

Remote Client Partitions introduce a method for managing private IP address assignments in a tenant's network, accommodating both local and remote devices under a unified addressing scheme. Each tenant begins with a superset of private IP addresses, some of which may already be partitioned into subnetworks for on-premises LAN locations. To extend these resources to remote users, the solution creates Remote Private Subnets (RPS)—subsets of the tenant's address space dedicated to endpoints running the NP client. Each NP gateway 320 fronts an RPS and is usually deployed in a geographic region close to the remote clients it serves, thereby reducing latency and optimizing routing. For fault tolerance, multiple NP gateways 320 can be designated per RPS—collectively known as Designated NP Gateways (DNPGs). Only one is active at a time (the Primary DNPG) due to WireGuard constraints, while the others (the Secondary DNPGs) remain on standby.

When an NP client is unable to connect to its Primary DNPG, it informs the system's broker, which may reassign the client to a newly elected Primary DNPG or to a DNPG from a neighboring RPS. In all cases, the client's virtual IP address is managed based on the RPS associated with the NP gateway 320 it connects to. Because NP gateways 320 initiate only outbound connections, there is no need to open inbound firewall ports, thereby maintaining a robust zero-trust posture. By assigning remote endpoints to RPS address pools and leveraging WireGuard tunnels between NP clients and NP gateways 320, the system offers LAN-like access to authorized remote devices without exposing the entire corporate network.

Although each NP gateway 320 fronts an RPS, it does not require an IP address within that subnet. Its primary function is to facilitate route selection and handle the “stitching” of two tunnels: one between the NP client and the NP gateway 320, and the other between the NP gateway 320 and the NP connector 302. This design keeps the NP gateway 320 agnostic to the specific IP space of the RPS while still enabling the secure transport of traffic. On the LAN side, private subnetworks are typically predefined within the tenant's infrastructure, existing prior to any NP solution deployment. As a result, the LAN partitioning is already in place, and NP merely extends network reach to remote devices. For fault tolerance, most implementations use at least two NP connectors 302 per LAN, configured in a redundant manner.

To handle gateway failover gracefully, the NP client is initially provided with only one NP gateway 320 (the Primary). It attempts to establish a WireGuard tunnel and then checks the tunnel status after a predefined interval. If tunnel creation fails, the NP client notifies the broker, which reassigns the client to another NP gateway 320—potentially a newly elected Primary DNPG or a DNPG from a neighboring RPS. In parallel, the broker manages NP gateway 320 leadership through a “leader election” process, updating the record in Wally (the zero-trust orchestration component) if leadership changes. If the broker detects a discrepancy—such as the broker believing the NP gateway 320 is operational while the client deems it unreachable—it triggers an error recovery procedure on the Primary NP gateway 320, prompting all tunnels to be restarted. Should these recovery steps fail, the broker designates a new Primary NP gateway 320 and instructs all NP clients within the affected RPS to migrate accordingly. In the event of a site-wide outage, the client is redirected to a different broker with a corresponding set of NP gateways, ensuring seamless connectivity and minimal downtime.

### Packet Flow/Tunnel Establishment

The NP connectors 302 maintain active tunnels to every known NP gateway 320, ensuring high availability and efficient traffic routing across the cloud-based system 100. By contrast, the NP clients initiate a WireGuard tunnel only when they come online and connect to the single NP gateway 320 closest to them geographically, minimizing latency. The NP gateways 320 themselves do not initiate any tunnels; instead, they host well-known IP addresses and ports so that the NP connectors 302 and the NP clients can reliably establish outbound connections. This design adheres to zero-trust principles by eliminating the need to open inbound ports. Once connected, the NP clients, the NP gateways 320, and the NP connectors 302 can dynamically add or remove peers as needed, leveraging WireGuard's native support for ephemeral peer discovery. Underneath these tunnels, actual data packets move between an NP client and an NP segment (or vice versa) via standard Layer 2/Layer 3 forwarding. The NP virtual adapters on each endpoint device 106 handle the encryption and encapsulation, while the NP gateways 320 effectively bridge the two legs of the tunnel—one from the NP client to the NP gateway 320, and the other from the NP gateway 320 to the NP connector 302—thus completing end-to-end secure communication.

### Application Brokers and NP Gateways

In most deployments, the NP gateways 320 and application brokers 346 (which facilitate ZTNA private application access) are co-located to streamline communication and reduce latency. By combining ZTNA private application access with a ZTNA-enabled VPN, the application brokers 346 leverage the NP-Wally module 340 to remain aware of available NP gateways and provide initial configuration data-often referred to as bootstrapping information—to the client connector 130 (including the NP client). This information includes details such as the NP gateway's IP address and port, cryptographic keys or tokens, and any required routing policies for tunnel establishment. On the server side, the same brokers are also responsible for securely fetching the NP-Wally module credentials on behalf of the NP connector 302, allowing both the client connector and NP connector to authenticate and update key materials without direct access to Wally. Notably, the NP gateways 320 themselves connect directly to the NP-Wally module 340 and remain unaware of the broker's presence, thereby simplifying the gateway's design and focusing its functionality on managing secure tunnels rather than orchestrating session or identity logic. This layered approach ensures that client connectors, NP connectors, and NP gateways each have precisely the information they need to maintain a zero-trust security posture while offering seamless connectivity for both application-level and network-level access.

### Tunnels and Peering

The NP connectors 302 maintain active tunnels to all known NP gateways 320, as published by the NP-Wally module 340. Whenever a new NP gateway is added, removed, or updated (e.g., due to a key-pair change), the NP-Wally module notifies NP connectors accordingly. Unlike the existing ZTNA mechanism, in which a remote endpoint's data might pass through an application-layer proxy, the NP approach uses Layer 3 forwarding to carry traffic from an endpoint device 106 to an NP segment. Consequently, the NP connector 302-to-NP gateway 320 tunnels must be established proactively. Meanwhile, on the remote side, the NP client brings up its own tunnel to the NP gateway 320 as soon as it starts. By the time an application attempts to connect to an IP address served through Network Presence, both “legs” of the tunnel path are already in place, eliminating any delay from tunnel setup and ensuring zero-lag connectivity.

All NP components—NP clients, NP gateways 320, and NP connectors 302—use WireGuard to establish secure tunnels. A given NP client forms a single tunnel to its assigned NP gateway 320, while each NP connector 302 forms tunnels with every NP gateway 320. Additionally, NP gateways 320 create peering connections only with other NP gateways 320, forming a mesh or partial mesh structure. WireGuard peers can only be created if both entities possess each other's public key, ensuring a mutual handshake and a strict trust boundary. This design means that peering relationships and tunnels can dynamically change in several scenarios:
(1) NP Client Startup—When an NP client comes online, its NP gateway 320 must add the client as a new WireGuard peer.
(2) Client Relocation—If an NP client moves to a different geographic region, it may change its NP gateway 320. In this case, the old gateway will remove its peering with the client, while the new gateway adds the client as a peer.
(3) Adding a New NP Gateway—All NP connectors 302 and existing NP gateways 320 must establish new peer connections for the newly introduced NP gateway.
(4) Adding a New NP Connector—Each NP gateway 320 updates its peer list to include the newly added NP connector 302.
(5) Decommissioning a Component—If an NP client, NP gateway, or NP connector is taken out of service, the corresponding WireGuard peers remove its public key and tear down any active tunnels.
(6) Key Rollover—When an endpoint (client, gateway, or connector) undergoes key-pair rotation, peer entries are updated with the new WireGuard public key, prompting reestablishment of secure tunnels.

Through this mechanism, Network Presence ensures continuous adaptability and resilience. Peering relationships evolve in real time, maintaining a secure mesh of connections even in dynamic environments with frequent changes.

### Process

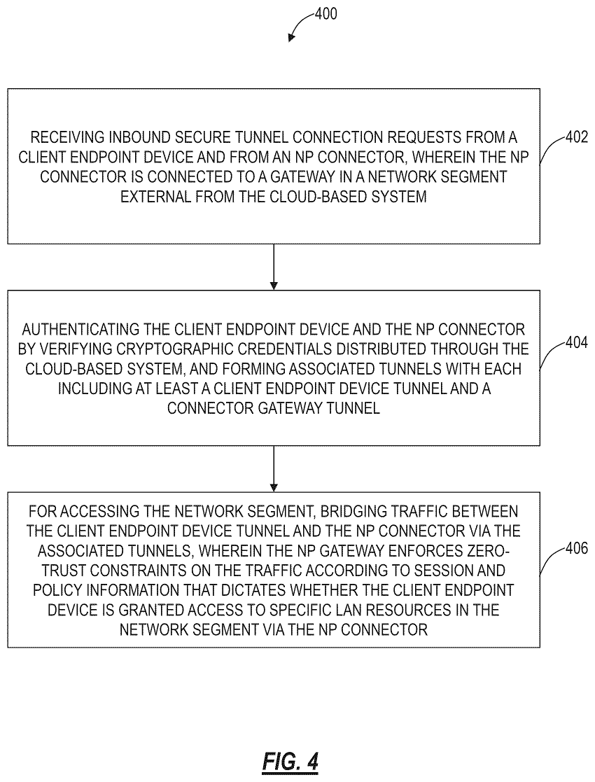

FIG. 4 illustrates a flowchart of a process 400 for enabling zero-trust network access (ZTNA)-enabled virtual private network (VPN) connectivity in a cloud-based system that includes a network presence (NP) gateway 320. The process 400 can be implemented as a method performed by a computing system configured to carry out the described steps, including but not limited to the NP gateway 320, or as instructions stored on a non-transitory computer-readable medium that, when executed by one or more processors, cause the described steps to be performed.

The steps include receiving inbound secure tunnel connection requests from a client endpoint device and from an NP connector, wherein the NP connector is connected to a gateway in a network segment external from the cloud-based system (step 402); authenticating the client endpoint device and the NP connector by verifying cryptographic credentials distributed through the cloud-based system, and forming associated tunnels with each including at least a client endpoint device tunnel and a connector gateway tunnel (step 404); and, for accessing the network segment, bridging traffic between the client endpoint device tunnel and the NP connector via the associated tunnels, wherein the NP gateway enforces zero-trust constraints on the traffic according to session and policy information that dictates whether the client endpoint device is granted access to specific LAN resources in the network segment via the NP connector (step 406).

The steps can further include, for accessing a second client endpoint device, bridging traffic between the client endpoint device tunnel and a second client endpoint device tunnel to the second client endpoint device. The bridging traffic between the client endpoint device tunnel and the second client endpoint device is via the NP gateway when the client endpoint device tunnel and the second client endpoint tunnel are connected thereto; or via the NP gateway and one or more inter-gateway tunnels and one or more additional NP gateways when the second client endpoint tunnel is connected to a different NP gateway. The associated tunnels can include one or more inter-gateway tunnels and one or more additional connector gateway tunnels when the NP connector is connected to a different NP gateway than the NP gateway.

The steps can further include maintaining inter-gateway tunnels to other NP gateways for inter-gateway traffic flow without exposing inbound ports; and maintaining connector gateway tunnels including the connector gateway tunnel and any additional connector gateway tunnels to any additional NP connectors. The inter-gateway tunnels, the connector gateway tunnels, and the client endpoint device tunnel can use a WireGuard-based protocol. The maintaining can include key rotation events as well as addition and removal of NP gateways and NP connectors. The NP gateway is associated with a known Internet Protocol (IP) address and port pair and is configured for outbound-only connections, where the client endpoint device and the NP connector establish secure tunnels to the NP gateway via the known IP address, removing a need to open inbound ports.

The steps can further include, while maintaining parallel secure tunnels to multiple NP connectors each associated with distinct LAN segments, selectively forwarding traffic from the client endpoint device to an appropriate NP connector based on destination subnet definitions and based on the session and policy information. The steps can further include coordinating cryptographic key rotation events for both the client endpoint device and the NP connector, including the NP gateway updating its peer tables upon receiving new cryptographic credentials and gracefully reestablishes tunnels without disrupting live sessions. The steps can further include, for the inbound secure tunnel connection request from the client endpoint device, receiving tunnel-initiation information encapsulated by a client connector application executing on the client endpoint device, wherein the client connector application includes identification, posture, and policy tokens that the NP gateway verifies against zero-trust policies.

The steps can further include forwarding the inbound secure tunnel connection request from the client endpoint device to an application broker in the cloud-based system for application-specific zero-trust validation, wherein the client connector application also supports direct connectivity to an application connector for private application access. The steps can further include enforcing resource segmentation rules that differentiate between LAN-level NP traffic and application-level connections, so that only authorized traffic is forwarded toward the NP connector or the application connector, respectively. The steps can further include obtaining, from a broker service in the cloud-based system, the session and policy information that dictates whether the client endpoint device is granted access to specific LAN resources via the NP connector.

### Co-Existence of Zero Trust Tunnel and VPN Tunnel

As described herein, the client connector 120 supports a dual-tunnel approach, providing both ZTNA private application access to applications 102 and ZTNA-enabled VPN connectivity for network segments. In one mode, the client connector 120 establishes a zero-trust tunnel (e.g., TLS or SSL) that directs application-level traffic to the application connector 130, ensuring per-application, least-privileged access. In parallel, the client connector 120 creates a network-layer tunnel—referred to as a GW-client tunnel 356—with the NP gateway 320, which bridges traffic to NP connectors 302 for LAN segments or to another endpoint device 106 as required. This design allows organizations to differentiate traffic flows based on application type or port requirements, automatically routing data either through the zero-trust tunnel for granular, application-specific controls or through the VPN-like network-layer tunnel where broader connectivity (e.g., for VoIP or server-initiated flows) is necessary. By consolidating both approaches within a single ZTNA product, the client connector 120 simultaneously delivers the security benefits of ZTNA—such as least-privileged access and continuous policy enforcement—alongside persistent network-layer connectivity for real-time or legacy use cases. This unified architecture eliminates the need for multiple, disjoint solutions and provides a seamless, centrally managed framework that intelligently orchestrates traffic based on context, device posture, user identity, and application demands.

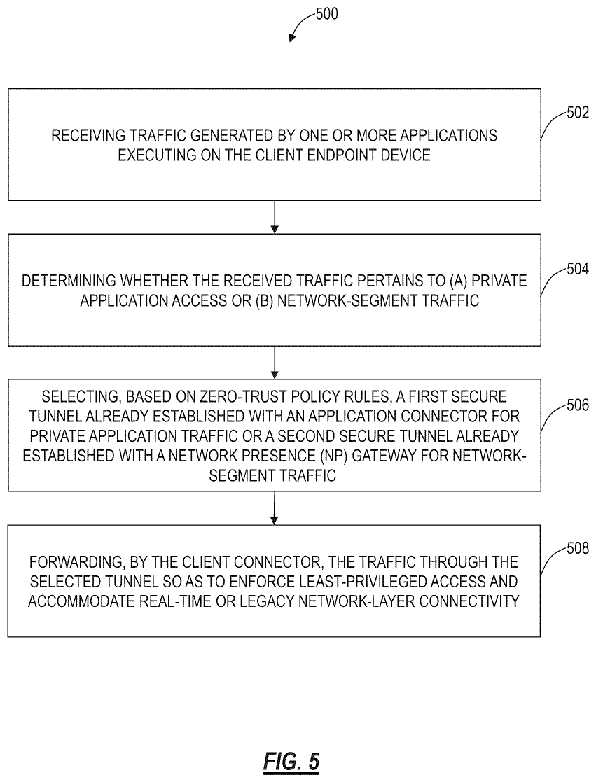

FIG. 5 illustrates a flowchart of a process 500 for providing zero-trust network access (ZTNA) private application connectivity and ZTNA-enabled virtual private network (VPN) connectivity. The process 500 is described with reference to a client endpoint device 106 that includes a client connector 120. The process 500 can be implemented as a method performed by a computing system configured to carry out the described steps, including but not limited to the client endpoint device 106, or as instructions stored on a non-transitory computer-readable medium that, when executed by one or more processors, cause the described steps to be performed.

The steps include receiving traffic generated by one or more applications executing on the client endpoint device (step 502); determining whether the received traffic pertains to (a) private application access or (b) network-segment traffic (step 504); selecting, based on zero-trust policy rules, a first secure tunnel already established with an application connector for private application traffic or a second secure tunnel already established with a network presence (NP) gateway for network-segment traffic (step 506); and forwarding the traffic through the selected tunnel so as to enforce least-privileged access and accommodate real-time or legacy network-layer connectivity (step 508).

The steps can further include establishing, by the client connector prior to receiving the traffic, the first secure tunnel to the application connector using an outbound-only connection, wherein application-specific zero-trust policies are enforced at an application layer. The steps can also further include establishing, by the client connector, the second secure tunnel to the NP gateway via an outbound-only connection, wherein network-segment traffic is routed at the network layer while upholding a zero-trust security posture. The steps can further include analyzing traffic attributes—including destination IP, port, protocol, or application identifier—against policy data stored in the client connector, and selecting either the first secure tunnel or the second secure tunnel in real time based on those attributes.

Both the first secure tunnel and the second secure tunnel are established as outbound connections from the client endpoint device, ensuring no inbound ports are opened at the client endpoint device and maintaining a zero-trust security posture. The first secure tunnel can include a TLS/SSL-based connection with the application connector at an application layer; and the second secure tunnel can include a network-layer tunnel utilizing a protocol selected from the group consisting of WireGuard, IPsec, or a functionally equivalent secure VPN protocol.

The steps can further include performing, at the client connector, periodic device posture checks (including operating system version, security patches, or endpoint health) and automatically adjusting tunnel access if a posture check fails or indicates non-compliance. The steps can further include directing, by the client connector, latency-sensitive or server-initiated traffic flows (including VoIP or remote management protocols) through the second secure tunnel, while routing purely application-specific requests through the first secure tunnel. The steps can further include participating, by the client connector, in a cryptographic key rollover mechanism managed by a broker system, wherein both the first secure tunnel and the second secure tunnel are re-keyed without disrupting active sessions. The steps can further include exposing, via a single management interface of the client connector, consolidated configuration options for both the application-layer tunnel and the network-layer tunnel, enabling an administrator to update zero-trust policies or revoke access globally without installing multiple clients.

### WireGuard Tunnels in Communication Networks

FIG. 6 is a diagram illustrating an embodiment of an IP communication network 600 for delivering packets, particularly with respect to transmission via WireGuard tunnels. As shown in this embodiment, the IP communication network 600 includes a cloud-based system 602, which may be the same as or similar to the cloud-based system 100, Internet 108, cloud services 110, an enterprise network, data center, private cloud, public cloud, etc. The cloud-based system 602 may be configured with a plurality of cloud-based applications (apps) for providing services to clients. For example, the apps may include Zero Trust Network Access (ZTNA) apps, client connection apps (e.g., ZCC), Internet access apps (e.g., ZIA), etc. The IP communication network 600 may utilize various tunneling protocols (e.g., WireGuard) for offering simple and fast VPN services. The cloud-based system 602 is configured to communicate with a client network 604 (or multiple client networks), which may include transmitting IP packets in a secure manner from the cloud-based system 602 to the client network 604.

The cloud-based system 602 includes, among other things, a source 606 that is connected via a tunnel 608 to a gateway device 610. In some embodiments, the source 606 may be the same as or similar to the NP connectors 302, apps 102 (e.g., ZTNA app), app connectors 130, LAN segments 306, etc. described above. In some embodiments, the tunnel 608 may be the same as or similar to the tunnels 326, 328, 330, 332 described above. Also, according to some embodiments, the gateway device 610 may be the same as or similar to the NP gateways 320 or other suitable interfaces (e.g., WireGuard interface). Another tunnel 612 is used for securely communicating packets from the cloud-based system 602 to the client network 604. In some embodiments, the tunnel 612 may be the same as or similar to the GW-client tunnels 322 described above.

In addition, the client network 604 includes a connector 614 configured to communicate with the gateway device 610 of the cloud-based system 602 via the tunnel 612. In some embodiments, the connector 614 may the same as or similar to the client connectors 120 described above and/or may be configured as an edge device (at the edge of the client network 604), an intermediate node, a WireGuard peer, a crypto peer, etc. The connector 614 is configured to communicate with a client device 616. In some embodiments, the client device 616 may be the same as or similar to the clients or endpoint devices 106 and/or may be configured as a user device, a host, a host device, a destination device, etc. Since the connector 614 and client device 616 are arranged in the same client network (e.g., client network 604), a regular IP connection may be used between them since a tunnel would normally not be needed at this point.

With respect to the WireGuard tunneling protocol, the embodiment shown in FIG. 6 would include a packet transmission technique that may be considered to be fairly straightforward. As the only connector in this arrangement, the connector 614 would be designated as the WireGuard peer with respect to the gateway device 610. While operating according to the WireGuard protocol, the gateway device would receive a packet from the source 606 addressed to the IP address of the client device 616. The gateway device 610 would transmit the packet over the tunnel 612 to the connector 614, which would then forward the packet to the client device 616.

However, it may be noted that transmission from source 606 to client device 616 is confined to this one singular path. Therefore, if there is congestion along this path or any faults are detected, there are no alternative paths available for communicating between the source 606 and client device 616. Nevertheless, the following implementations are configured to enable additional options for securely transmitting packets under the WireGuard protocol.

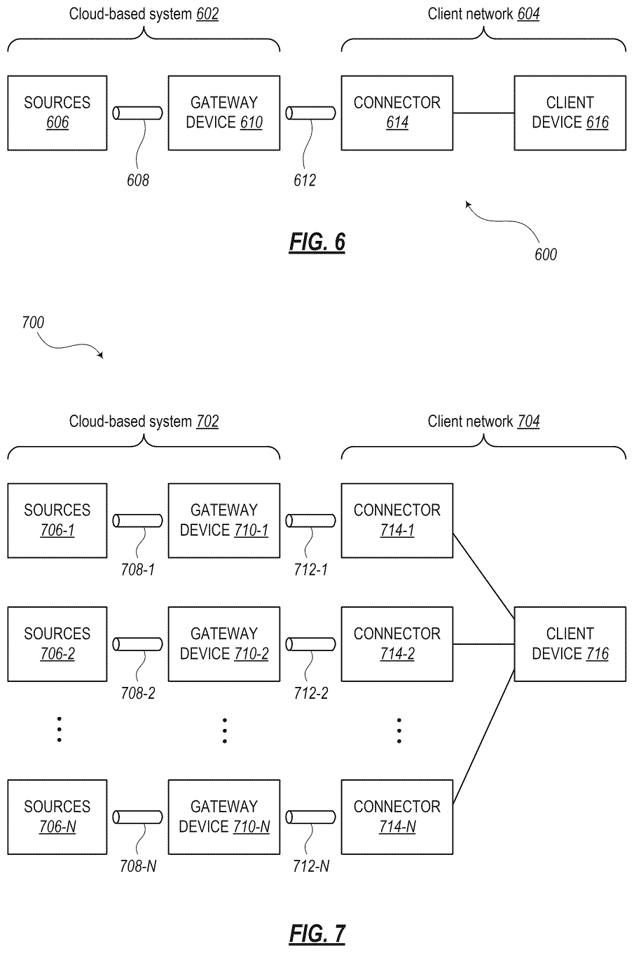

FIG. 7 is a diagram illustrating an embodiment of another IP communication network 700 for delivering packets from sources to a client device. As shown, the IP communication network 700 includes a cloud-based system 702 and client network 704. The cloud-based system 702 includes multiple sources 706-1, 706-2, . . . , 706-N connected via tunnels 708-1, 708-2, . . . , 708-N to multiple gateway devices 710-1, 710-2, . . . , 710-N, respectively. Even using the WireGuard protocol, the gateway devices 710 can communicate via tunnels 712-1, 712-2, . . . , 712-N to multiple connectors 714-1, 714-2, . . . , 714-N, respectively, of the client network 704. Each of the connectors 714 is further connected to the client device 716, thereby allowing multiple parallel paths from the sources 706 to the client device 716. However, it may be noted that in order to implement WireGuard, each gateway device 710 is paired with a corresponding connector 714 as WireGuard peers. A packet from a corresponding source 706 is communicated to the corresponding WireGuard peer via the corresponding tunnel 712. It may also be noted, however, that in order to enable these parallel paths, additional gateway devices 710 and additional tunnels 708 would be needed in this scenario.

WireGuard Tunneling System with Single Gateway Device

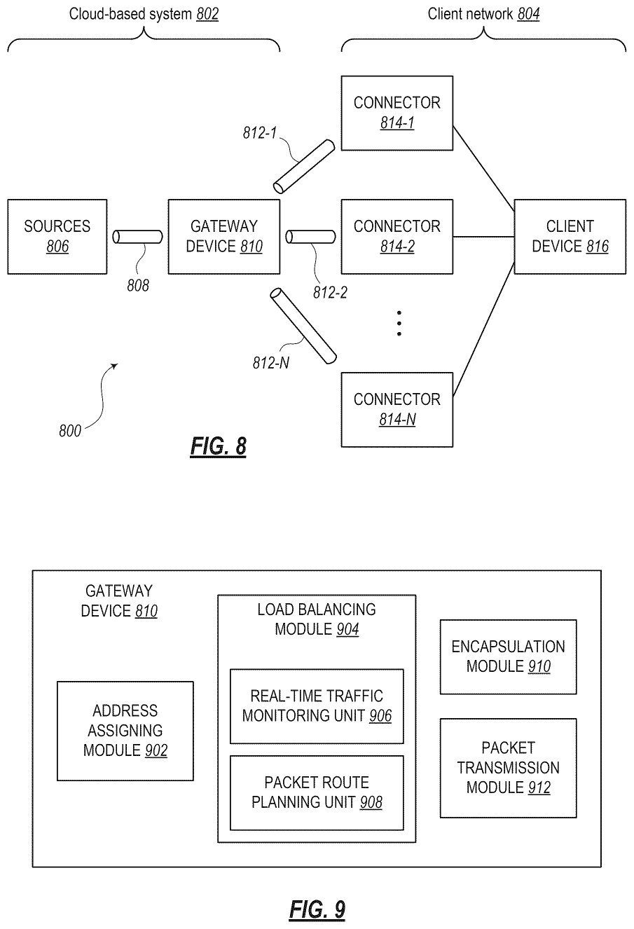

FIG. 8 is a diagram illustrating an embodiment of yet another IP communication network 800 for delivering packets from sources to a client device. In some respects, the IP communication network 800 represents a preferred embodiment with respect to communicating packets in a system while also offering “load balancing” with respect to the WireGuard tunneling protocol. As shown in FIG. 8, the IP communication network 800 includes a cloud-based system 802 and a client network 804. The cloud-based system 802 includes sources 806 connected through one or more tunnels 808 to a gateway device 810. In this embodiment, it should be noted that only a single gateway (e.g., gateway device 810) is included, while still allowing the functionality of WireGuard tunneling.

Again, WireGuard is a communication protocol that utilizes tunnels and implements encrypted VPNs. As a tunneling protocol, WireGuard is lighter, more efficient, and performs better than IPsec, OpenVPN, and SSL. The WireGuard protocol passes traffic over User Datagram Protocol (UDP), which is one of the main communication protocols of the Internet Protocol (IP) suite used to send messages (e.g., configured as datagrams within packets) to a host (e.g., client device 816) on an IP network (e.g., IP communication network 800). Within the IP network, UDP does not require prior communication to set up channels or data paths. UDP is a connectionless protocol, meaning that messages are sent without negotiating a connection (e.g., no handshaking).

Furthermore, the WireGuard protocol introduces “crypto-peers,” wherein the peer IP and a packet addressed to a certain destination (e.g., client device 816) may be sent to this destination through only one crypto-peer (e.g., connector 814) at any one time. Traffic in WireGuard is encrypted and encapsulated in UDP. According to the conventional operation of WireGuard, the peer configuration has an “AllowedIP” setting, whereby a packet addressed to some destination (e.g., client device 816) can only be sent via one designated WireGuard peer (e.g., connector 814-1), if and only if this connector 814-1 is configured with an AllowedIP configuration that subsumes the IP address of the client device 816. As mentioned above, however, this feature of WireGuard can be constraining in that it does not allow use of the parallel paths through the other connectors 814-2, . . . , 814-N.

As an illustrative example, consider the gateway device 810 connected to at least two connectors 814. Assume that the client device 816 (e.g., LAN segment) has an IP address 1.1.1.1/32 and is reachable via the at least two connectors 814. The gateway device 810 may be configured to see the at least two connectors 814 as egress points to reach 1.1.1.1/32. However, the gateway device 810 may be configured to assign 1.1.1.1/32 as an AllowedIP entry only under one crypto peer (e.g., connector 814-1) or another (e.g., connector 814-2), but not both. This is a limitation in the protocol since, although at least one other forwarding path exists to the same destination (e.g., client device 816), it cannot be utilized for load balancing during conventional operation of the WireGuard protocol. This problem even becomes more acute in case of more than two forwarding paths, as is shown in FIG. 8. In essence, any type of Equal Cost Multi-Path (ECMP) or Unequal Cost Multi-Path (UCMP) benefits are not possible with the conventional WireGuard functionality.

Nevertheless, the systems and methods of the present disclosure are configured to overcome this limitation of WireGuard to open up multiple paths, which thereby provides numerous benefits. One benefit, for example, is the recovery to a secondary route when a primary route is down (e.g., faulty, congested, etc.). Also, with multiple parallel paths, load balancing functions can be implemented, as described in the present disclosure, thereby providing faster and more efficient packet transmission.

Therefore, to implement this load balancing feature within the WireGuard protocol, the systems and methods of the present disclosure are configured to bypass a normal WireGuard limitation related to the selection of a single crypto-peer from the AllowedIP list. The idea utilized herein, according to various embodiments, includes specific handling of arriving traffic at the gateway device 810. That is, the gateway device 810 is configured to encapsulate the destination IP address of the host (e.g., client device 816), as an inner IP packet, such that the destination IP is an AllowedIP entry under another selected crypto peer (e.g., connector 814-2).

To achieve this, the encapsulation involves an outer IP address of a loopback interface at each of the connectors 814-1, 814-2, . . . , 814-N and gateway device 810 to assign these loopback IP addresses that do not conflict with customer subnets. The gateway device 810 can utilize previously unassigned address space, such as class E addresses ranging from 240.0.0.0 to 255.255.255.255 (in IPv4). For example, the gateway device 810 may assign 241.10.1.1/32 as the loopback for itself and may similarly assign 242.10.1.1/32, 242.10.1.2/32, . . . , 242.10.1.N/32 to connectors 814-1, 814-2, . . . , 814-N, respectively. These IP addresses are also populated into the AllowedIP list under the respective crypto peers.

For instance, at the gateway device 810, the AllowedIP list for the first crypto peer (e.g., connector 814-1) may be {1.1.1.1/32, 242.10.1.1/32}. Also, the AllowedIP list for the second crypto peer (e.g., connector 814-2) may be {1.1.1.1/32, 242.10.1.2/32}, and so on. When an IP packet is received at the gateway device 810 destined to 1.1.1.1/32 (e.g., the client device 816), the gateway device 810 can make a decision based on the (source, destination) tuple. That is, from a source 806 with IP address 2.2.2.2/32, the gateway device 810 may send (2.2.2.2/32, 1.1.1.1/32) to the first crypto peer (e.g., connector 814-1), and, from a source 806 with IP address 3.3.3.3/32, the gateway device 810 may send (3.3.3.3/32, 1.1.1.1/32) to the second crypto peer (e.g., connector 814-2), and so on, after encapsulating with the class E address of the respective connector 814.

In the situation where the connector 814-1, for instance, is designated as the crypto peer, then, the gateway device 810 does not necessarily need to encapsulate the packet since WireGuard can then operate under its normal functionality. When the connector 814-1 receives the packet, it finds the destination IP to be 1.1.1.1/32 and will send to the eventual destination (e.g., client device 816) as per the forwarding table entry for 1.1.1.1/32.

On the other hand, in the situation where another connector 814 is selected for receiving a packet within the load balancing technique described herein, then, when this other connector 814 receives the packet, it finds the destination to be the class E address (of itself) and infers that this is an encapsulated traffic as per previous description. Then, it will do a decapsulation (e.g., popping off the top address) again to get at the original inner IP address and will send to the eventual destination (e.g., client device 816) as per the forwarding table entry for 1.1.1.1/32.

The gateway device 810 may utilize the following table regarding AllowedIP address lists (or stacks) for crypto peers:

| Crypto Peer | AllowedIP List |
|---|---|
| Connector 814-1 | 1.1.1.1/32 |
| | 242.10.1.1 |
| Connector 814-2 | 1.1.1.1/32 |
| | 242.10.1.2 |
| . . . | . . . |
| Connector 814-N | 1.1.1.1/32 |
| | 242.10.1.N |

It may be noted that traffic intended for destination 1.1.1.1/32 (e.g., client device 816) and yet directed to a connector other than the original crypto peer (e.g., connector 814-1), such as being directed to one of connectors 814-2, . . . , 814-N (e.g., based on load balancing calculations), will involve another encapsulation in addition to the 1.1.1.1/32 address. Therefore, this strategy facilitates load balancing in WireGuard without making any changes to the WireGuard source code. This can easily be deployed with minimal changes to the configuration, with merely an extra encapsulation at the sending side and an extra decapsulation at the receiving side.

Gateway Device with Load Balancing Capabilities in WireGuard Environment

FIG. 9 is a block diagram illustrating an embodiment of the gateway device 810 shown in FIG. 8. In this implementation, the gateway device 810 includes, among other things, an address assigning module 902 configured, in a set-up stage, to assign IP addresses to the connectors 814-1, 814-2, . . . , 814-N to uniquely identify each connector 814. The address assigning module 902 is configured to perform the assigning of IP addresses to establish a new identifying scheme that can then be used to enable communication over multiple parallel paths while working within the WireGuard protocol.

Also, the gateway device 810, as shown in FIG. 9, includes a load balancing module 904 having a real-time traffic monitoring unit 906 and a packet route planning unit 908. Essentially, the load balancing module 904 is configured to balance the load of packet transmission over the multiple tunnels 812 based on various factors with respect to the availability of routes, congestion on the various routes, transmission costs, faulty routes, etc. Based on the real-time data obtained by the real-time traffic monitoring unit 906, the packet route planning unit 908 is configured to determine how traffic routing can be divided along the tunnels 812 for transmission to the connectors 814 in the client network 804. Again, this packet routing along multiple parallel paths would not normally be possible with the conventional WireGuard operations. However, by encapsulating the packets with the unique IP addresses pre-established by the address assigning module 902, the packet route planning unit 908 can direct packets along the various tunnels 812 to reduce latency, avoid problematic routes, balance the packet load, or otherwise optimize the routing for fast and error-free transmission.

Therefore, the gateway device 810 is configured to utilize the multiple tunnels 812 while also taking advantage of the benefits of WireGuard tunneling features. Once the packet traffic has been determined based on available parameters of the tunnels 812, as analyzed by the packet route planning unit 908, the gateway device 810 is configured to perform an encapsulation procedure using an encapsulation module 910. The encapsulation module 910 is configured to encapsulate each of the packets with the new IP addresses assigned by the address assigning module 902 based on the detected load-balanced routing as determined by the packet route planning unit 908. Once the plan for routing the multiple packets has been determined and the packets (when necessary) are encapsulated to distribute them among the different connectors 814, a packet transmission module 912 of the gateway device 810 is configured to transmit the packets accordingly.

In this way, a packet is routed over the pre-established tunnel of one of the routes available in the AllowedIP list, while also bypassing the restriction of the conventional WireGuard protocol that only allows transmission via the one designated crypto peer. Once the packet is tunneled to the corresponding connector 814, the connector 814 pops this address, observes that the next address is the IP address of the client device 816 (e.g., destination), and sends the packet to the client device 816. This process is performed for each packet on each connector 814 to thereby equally distribute the load among the available tunnels 812 to direct the packets to the client device 816 via multiple connectors 814. It may be noted that the encapsulation and routing can be performed by the gateway device 810 without involvement by the connectors 814 on the client network 804. The connectors 814 receive the packets (over the tunnels 812 in a secure manner) and simply forward the packet to the next address in the IP header (i.e., the IP address of the client device 816).

Therefore, the gateway device 810 may be configured to extend, enhance, and/or improve the WireGuard protocol to provide a load balancing functionality. The gateway device 810 is arranged in a cloud-based system and connected via tunnels to multiple connectors in a client network. The gateway device 810 is configured to perform a step of assigning loopback IP addresses to the multiple connectors and populating the loopback IP addresses into AllowedIP lists associated with the multiple connectors. The multiple AllowedIP lists addressing the connectors as crypto peers are for use with the WireGuard protocol. Based on network operating parameters, the gateway device 810 is configured to perform a step of determining a packet routing plan for distributing multiple packets among the connectors. When a packet of the multiple packets is determined, according to the packet routing plan, to be routed through a connector other than a designated WireGuard peer, the gateway device 810 is further configured to encapsulate the packet with the corresponding loopback IP address of the connector.

In some embodiments, the gateway device may be further configured to perform steps of a) receiving the multiple packets from one or more sources arranged in the cloud-based system, and b) forwarding the multiple packets, via the tunnels and multiple connectors, to a client device arranged in the client network. Also, each of the multiple packets may include payload and an IP header, wherein the IP header may include at least a (source, destination) tuple, and wherein the destination of the tuple may be associated with the client device. The step of forwarding the multiple packets, for example, may include transmitting the multiple packets in such a way so as to essentially balance the load among multiple paths, each of the multiple paths including one of the tunnels and one of the multiple connectors.

According to some embodiments, the steps may be performed so as to extend the WireGuard protocol to support a load balancing strategy for substantially balancing the load among parallel network paths leading to a host node in the client network. The load balancing strategy, for example, may be adapted to account for one or more of a) packet size of each of the multiple packets, b) routing costs of each of network paths, c) latency along the network paths, d) the availability and fault status of the network paths, e) Equal Cost Multi-Path (ECMP) factors, f) Unequal Cost Multi-Path (UCMP) factors, and g) the availability of backup, protection, or recovery paths.

Furthermore, the multiple connectors may be configured as edge devices arranged to delineate an edge of the client network. The loopback IP addresses, for example, may be class E addresses in IPv4 ranging from 240.0.0.0 to 255.255.255.255. The packet routing plan for distributing multiple packets among the connectors, according to some implementations, may be configured to bypass a restriction of the WireGuard protocol regarding transmission of packets through the designated WireGuard peer. The cloud-based system, for example, may be a Zero-Trust Network Access (ZTNA) Virtual Private Network (VPN) system. In addition, the gateway device may further be configured to perform a step of assigning a loopback IP address to itself. Also, when a packet of the multiple packets is determined, according to the packet routing plan, to be routed through the designated WireGuard peer, the gateway device may be configured to bypass the encapsulating step.

In some embodiments, the gateway device may further be configured to perform steps of a) encrypting the multiple packets according to the WireGuard protocol, and b) encapsulating the multiple packets in a User Datagram Protocol (UDP) packet according to the WireGuard protocol. The multiple packets determined to be routed through connectors other than the designated WireGuard peer, for example, may be encapsulated twice. The gateway device may transmit the multiple packets to the multiple connectors such that 1) the connector designated as the WireGuard peer is able to obtain a destination IP address of a host device on the client network and transmit the packet accordingly, and 2) one or more connectors not designated as the WireGuard peer are able to infer the loopback IP address as encapsulated traffic, decapsulate the packet to obtain the destination IP address, and transmit the packet accordingly. The gateway device, for example, may be configured as a WireGuard interface.

### Load Balancing Process for Extending WireGuard Protocol

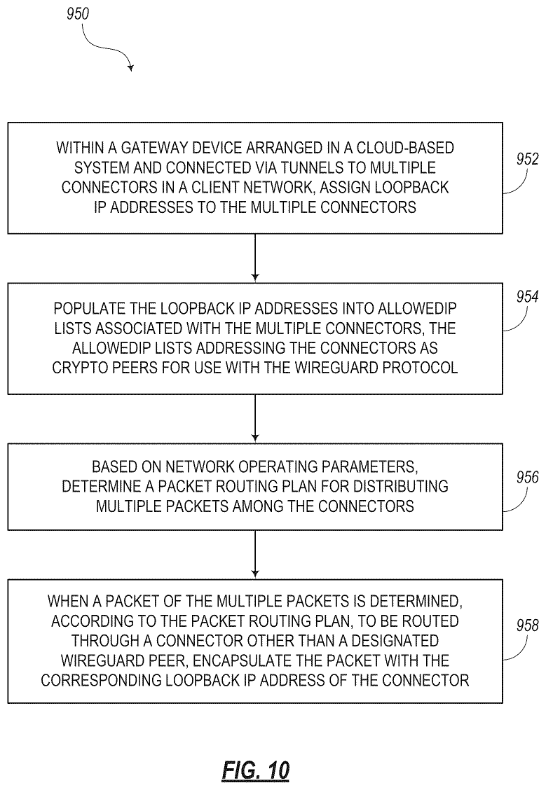

FIG. 10 is a flowchart illustrating an embodiment of a process 950 for balancing a load of packet transmissions within the WireGuard protocol. The process 950, for example, may be executed by the gateway device 810 or other suitable cloud-based interface for balancing a load among multiple connectors, client connectors, edge devices, intermediate nodes, WireGuard peers, crypto peers, or other suitable connection device internal to a client network configured as intermediate devices for forwarding packets to a host device (e.g., client device 616, 716, 816.

As shown in the embodiment of FIG. 10, the process 950 includes block 952 wherein, within a gateway device arranged in a cloud-based system and connected via tunnels to multiple connectors in a client network, the process 950 includes a step of assigning loopback IP addresses to the multiple connectors. The process 950 further includes a step of populating the loopback IP addresses into AllowedIP lists associated with the multiple connectors, as indicated in block 954. The multiple AllowedIP lists address the connectors as crypto peers are for use with the WireGuard protocol. Based on network operating parameters, the process 950 includes a step of determining a packet routing plan for distributing multiple packets among the connectors, as indicated in block 956. According to block 958, when a packet of the multiple packets is determined, according to the packet routing plan, to be routed through a connector other than a designated WireGuard peer, the process 950 includes encapsulating the packet with the corresponding loopback IP address of the connector.

In some embodiments, the process 950 may be further include steps of a) receiving the multiple packets from one or more sources arranged in the cloud-based system, and b) forwarding the multiple packets, via the tunnels and multiple connectors, to a client device arranged in the client network. Also, each of the multiple packets may include payload and an IP header, wherein the IP header may include at least a (source, destination) tuple, and wherein the destination of the tuple may be associated with the client device. The step of forwarding the multiple packets, for example, may include transmitting the multiple packets in such a way so as to essentially balance the load among multiple paths, each of the multiple paths including one of the tunnels and one of the multiple connectors.

According to some embodiments, the steps may be performed so as to extend the WireGuard protocol to support a load balancing strategy for substantially balancing the load among parallel network paths leading to a host node in the client network. The load balancing strategy, for example, may be adapted to account for one or more of a) packet size of each of the multiple packets, b) routing costs of each of network paths, c) latency along the network paths, d) the availability and fault status of the network paths, e) Equal Cost Multi-Path (ECMP) factors, f) Unequal Cost Multi-Path (UCMP) factors, and g) the availability of backup, protection, or recovery paths.

Furthermore, the multiple connectors may be configured as edge devices arranged to delineate an edge of the client network. The loopback IP addresses, for example, may be class E addresses in IPv4 ranging from 240.0.0.0 to 255.255.255.255. The packet routing plan for distributing multiple packets among the connectors, according to some implementations, may be configured to bypass a restriction of the WireGuard protocol regarding transmission of packets through the designated WireGuard peer. The cloud-based system, for example, may be a Zero-Trust Network Access (ZTNA) Virtual Private Network (VPN) system. In addition, the process 950 may further include a step of assigning a loopback IP address to the gateway device. Also, when a packet of the multiple packets is determined, according to the packet routing plan, to be routed through the designated WireGuard peer, the process 950 may be configured to bypass the encapsulating step.

In some embodiments, the process 950 may further include steps of a) encrypting the multiple packets according to the WireGuard protocol, and b) encapsulating the multiple packets in a User Datagram Protocol (UDP) packet according to the WireGuard protocol. The multiple packets determined to be routed through connectors other than the designated WireGuard peer, for example, may be encapsulated twice. The process 950 may transmit the multiple packets to the multiple connectors such that 1) the connector designated as the WireGuard peer is able to obtain a destination IP address of a host device on the client network and transmit the packet accordingly, and 2) one or more connectors not designated as the WireGuard peer are able to infer the loopback IP address as encapsulated traffic, decapsulate the packet to obtain the destination IP address, and transmit the packet accordingly. The gateway device, for example, may be configured as a WireGuard interface.

### Additional Considerations

In some embodiments (e.g., FIG. 7), there may be multiple interfaces or gateway device 710. This embodiment shows one way to overcome the WireGuard restriction that only allows an interface to connect through one designated peer device. In this case, each gateway device 710 corresponds with a respective connector 714. However, this involve incorporating many more gateway interfaces. Then, the system can have the AllowedIP of the client device 716 be reachable through connectors 714-1, 714-2, . . . , 714-N, because they are effectively different interfaces.

Furthermore, although this may be a viable solution, the embodiment of FIG. 8 is configured to achieve the same functionality with just one interface, which is where the embodiments described in the present disclosure come in. Therefore, coming into the gateway device 810 (i.e., a single interface) from the sources 806, the gateway device 801 is configured to encapsulate according to whether or not an intended path passes through the predetermined WireGuard peer.

For instance, let's say the destination node (e.g., client device 816) has an IPv4 address of 1.1.1.1. If the AllowedIP is the same, 1.1.1.1 is configured by the gateway device 810 on one of the connectors (e.g., connector 814-1). This enables WireGuard communication via connector 814-1. If it is configured this way, the packet will go there. However, according to the WireGuard protocol, packets cannot be sent to the other connectors (e.g., connectors 814-2, . . . , 814-N), because the IP address 1.1.1.1 is already taken or configured on connector 814-1.

This is the limitation of WireGuard, where a packet addressed to 1.1.1.1 can reach the client device 816 only through the designated WireGuard peer (e.g., connectors 814-1). However, according to the embodiments described herein, the present disclosure is configured to take advantage of the WireGuard, while also bypassing this “one path” limitation of WireGuard, so as to offer a load balancing technique. In one example, the gateway device 801 may assign class E addresses configured for the multiple connectors 814. These may be considered to be loopback addresses. For example, the separate class E IP addresses may assigned as 241.10.1.1 for the gateway device 810 itself and assign the connectors 814 with 242.10.1.1, 242.10.1.2, . . . , 242.10.1.N, respectively. These can be configured as the AllowedIP addresses on the peers at the gateway device 810. Thus, one is directed to connector 814-1 having an address 241.10.1.1 as the AllowedIP. Towards the second connector 814-2, the system can configure it as 242.10.1.2, and so on.

Let's say two traffic flows are coming from the sources 806 (e.g., client connector apps, network access apps, etc.), and they have the same destination address (e.g., 1.1.1.1), but different source addresses (e.g., 2.2.2.2, 3.3.3.3, etc.). As per forwarding, what happens is the gateway device 810 is configured to go through the designated WireGuard peer (e.g., connector 814-1). Due to the hashing or the like, the gateway device 810 may try to send to one of the other connectors, but because of the base WireGuard restriction, it will drop the packet because the destination is not allowed towards these other connectors.

Therefore, in accordance with the embodiments of the present disclosure, the gateway device 810 can encapsulate in the traffic that is directed, let's say, towards connector 814-2 having an outer destination address of 242.10.1.2. Since it is not the designated peer, the gateway device 810 can encapsulate since the outer IP would be 242.10.1.2, it can go to this second connector, because that is the AllowedIP address from the gateway device to the second connector. When this connector receives this, because in WireGuard, everything is coming via UDP. Once it is decrypted, the system can see the actual destination as 242.10.1.2, meaning the destination by a first decapsulation (or popping from the top of the stack) is 242.10.1.2. The second connector 814-2 would then need to further decapsulate the packet to allow it to get the intended IP packet address that came from the sources 806. This basically includes encapsulating the inner IP address and then decapsulating at the connectors 814. In some embodiments, such as the embodiment of FIG. 7, there may be any number of parallel connectors 814. Suppose, for example, there are 500 connectors and only a single interface at the gateway device 810.

The intermediate nodes (e.g., connectors 814) have the ability to access the host or destination (e.g., client device 816). In WireGuard, however, one cannot show the host being reachable from the same interface over multiple peers, because that breaks the WireGuard protocol and the packet would likely be dropped. What can be done, however, is utilize the encapsulation procedure (e.g., encapsulation module 910), whereby the connectors 814 know how to get to the host, but the host effectively becomes common for them, which WireGuard does not allow. However, the connectors 814 are distinct in their own presence and uniqueness in the network. So, what is done is for those distinct points over that WireGuard interface is to do the encapsulation for anything beyond them in the client network 804, kind of like a proxy. The system can identify those distinct points to enable transmission over the same WireGuard interface. This enables load balancing through them, however many there may be to reach the host.

The system may perform a hash function for the, say, 500 AllowedIPs to all get to the host. The system is going to run its hash for load balancing and may select, say, connector #320. It's going to put that AllowedIP on that packet with the 1.1.1.1 on the inner, and send it away. Also, if a preferred path goes down for whatever reason, then nothing changes here, because the hash would go to any suitable surviving connector, and they can automatically encapsulate.

WireGuard uses UDP, so effectively when a packet is sent through WireGuard, WireGuard will take the payload and the IP header of that packet, it will encrypt it, it will put it inside a UDP packet with an IP header in front of it, and send it up. In the past, SSL and TLS may have been used, but it has been found that WireGuard is typically better because it has a lighter weight, and it gives more functionality. Also, it operates at Layer 3, so it has the ability to take advantage of any multi-path network over multiple networks paths. It allows for the application, whether it is TCP or UDP running inside WireGuard to allow all the benefits of TCP or UDP to take place, end to end, because with the sources 806, the system can basically use segments and terminate things.

### CONCLUSION

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps-even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement-whether collectively, separately, or in subsets-thereby broadening the range of potential embodiments.

What is claimed is:

1. A gateway device arranged in a cloud-based system and connected via tunnels to multiple connectors in a client network, the gateway device configured to perform steps of:
assigning loopback IP addresses to the multiple connectors and populating the loopback IP addresses into AllowedIP lists associated with the multiple connectors, the AllowedIP lists addressing the multiple connectors as crypto peers for use with WireGuard protocol;
based on network operating parameters, determining a packet routing plan for distributing multiple packets among the multiple connectors; and
when a packet of the multiple packets is determined, according to the packet routing plan, to be routed through a connector other than a designated WireGuard peer, encapsulating the packet with a corresponding loopback IP address of the multiple connector.

2. The gateway device of claim 1, further configured to perform steps of:
receiving the multiple packets from one or more sources arranged in the cloud-based system; and
forwarding the multiple packets, via the tunnels and multiple connectors, to a client device arranged in the client network.

3. The gateway device of claim 2, wherein each of the multiple packets includes payload and an IP header, wherein the IP header includes at least a (source, destination) tuple, and wherein the destination of the tuple is associated with the client device.

4. The gateway device of claim 2, wherein the step of forwarding the multiple packets includes transmitting the multiple packets in such a way so as to essentially balance a load among multiple paths, each of the multiple paths including one of the tunnels and one of the multiple connectors.

5. The gateway device of claim 1, wherein the steps are performed in order to extend the WireGuard protocol to support a load balancing strategy for substantially balancing the load among parallel network paths leading to a host node in the client network.

6. The gateway device of claim 5, wherein the load balancing strategy is adapted to account for one or more of a) packet size of each of the multiple packets, b) routing costs of each of network paths, c) latency along the network paths, d) availability and fault status of the network paths, e) Equal Cost Multi-Path (ECMP) factors, f) Unequal Cost Multi-Path (UCMP) factors, and g) availability of backup, protection, or recovery paths.

7. The gateway device of claim 1, wherein the multiple connectors are edge devices arranged to delineate an edge of the client network.

8. The gateway device of claim 1, wherein the loopback IP addresses are class E addresses in IPv4 ranging from 240.0.0.0 to 255.255.255.255.

9. The gateway device of claim 1, wherein the packet routing plan for distributing multiple packets among the multiple connectors bypasses a restriction of the WireGuard protocol regarding transmission of packets through the designated WireGuard peer.

10. The gateway device of claim 1, wherein the cloud-based system is a Zero-Trust Network Access (ZTNA) Virtual Private Network (VPN) system.

11. The gateway device of claim 1, further configured to perform a step of assigning a loopback IP address to itself.

12. The gateway device of claim 1, wherein, when a packet of the multiple packets is determined, according to the packet routing plan, to be routed through the designated WireGuard peer, the encapsulating step is bypassed.

13. The gateway device of claim 1, further configured to perform steps of:
encrypting the multiple packets according to the WireGuard protocol; and
encapsulating the multiple packets in a User Datagram Protocol (UDP) packet according to the WireGuard protocol;
wherein the multiple packets determined to be routed through connectors other than the designated WireGuard peer are encapsulated twice.

14. The gateway device of claim 13, further configured to perform a step of transmitting the multiple packets to the multiple connectors such that 1) the connector selected as the designated WireGuard peer is able to obtain a destination IP address of a host device on the client network and transmit the packet accordingly, and 2) one or more connectors not selected as the designated WireGuard peer are able to infer the loopback IP address as encapsulated traffic, decapsulate the packet to obtain the destination IP address, and transmit the packet accordingly.

15. The gateway device of claim 1, wherein the gateway device is configured as a WireGuard interface.

16. A method comprising steps of:
within a gateway device arranged in a cloud-based system and connected via tunnels to multiple connectors in a client network, assigning loopback IP addresses to the multiple connectors;
populating the loopback IP addresses into AllowedIP lists associated with the multiple connectors, the AllowedIP lists addressing the multiple connectors as crypto peers for use with WireGuard protocol;
based on network operating parameters, determining a packet routing plan for distributing multiple packets among the multiple connectors; and
when a packet of the multiple packets is determined, according to the packet routing plan, to be routed through a connector other than a designated WireGuard peer, encapsulating the packet with a corresponding loopback IP address of the multiple connector.

17. The method of claim 16, further comprising steps of:
receiving the multiple packets from one or more sources arranged in the cloud-based system; and
forwarding the multiple packets, via the tunnels and multiple connectors, to a client device arranged in the client network in such a way so as to essentially balance a load among multiple paths, each of the multiple paths including one of the tunnels and one of the multiple connectors;
wherein each of the multiple packets includes payload and an IP header, wherein the IP header includes at least a (source, destination) tuple, and
wherein the destination of the tuple is associated with the client device.

18. The method of claim 16, wherein the method is configured to extend the WireGuard protocol to support a load balancing strategy for substantially balancing a load among parallel network paths leading to a host node in the client network, and wherein the load balancing strategy is adapted to account for one or more of a) packet size of each of the multiple packets, b) routing costs of each of network paths, c) latency along the network paths, d) availability and fault status of the network paths, e) Equal Cost Multi-Path (ECMP) factors, f) Unequal Cost Multi-Path (UCMP) factors, and g) availability of backup, protection, or recovery paths.

19. A non-transitory computer-readable medium of a gateway device arranged in a cloud-based system and connected via tunnels to multiple connectors in a client network, the non-transitory computer-readable medium configured to store a logic program having instructions enabling a processing device to perform steps of:
assigning loopback IP addresses to the multiple connectors and populating the loopback IP addresses into AllowedIP lists associated with the multiple connectors, the AllowedIP lists addressing the multiple connectors as crypto peers for use with the WireGuard protocol;
based on network operating parameters, determining a packet routing plan for distributing multiple packets among the multiple connectors; and
when a packet of the multiple packets is determined, according to the packet routing plan, to be routed through a connector other than a designated WireGuard peer, encapsulating the packet with a corresponding loopback IP address of the multiple connector.

20. The non-transitory computer-readable medium of claim 19, wherein the instructions further enable the processing device to perform steps of:
encrypting the multiple packets according to the WireGuard protocol;
encapsulating the multiple packets in a User Datagram Protocol (UDP) packet according to the WireGuard protocol, wherein the multiple packets are determined to be routed through connectors other than the designated WireGuard peer are encapsulated twice; and
transmitting the multiple packets to the multiple connectors such that 1) the connector configured as the designated WireGuard peer is able to obtain a destination IP address of a host device on the client network and transmit the packet accordingly, and 2) one or more connectors not configured as the designated WireGuard peer are able to infer the loopback IP address as encapsulated traffic, decapsulate the packet to obtain the destination IP address, and transmit the packet accordingly.
